(19) United States
(12) Patent Application Publication
(10) Pub. No.: US 2025/0321337 A1
(43) Pub. Date: Oct. 16, 2025

(54) THREE-DIMENSIONAL PERCEPTION OF OBJECTS AND SURFACES IN UNDERWATER ENVIRONMENTS

(71) Applicant: Summer Robotics, Inc., Campbell, CA (US)

(72) Inventors: Gerard Dirk Smits, Los Gatos, CA (US); Steven Dean Gottke, Concord, CA (US)

(21) Appl. No.: 19/059,517

(22) Filed: Feb. 21, 2025

Related U.S. Application Data
(60) Provisional application No. 63/556,663, filed on Feb. 22, 2024.

(51) Int. Cl. G01S 17/93; G01S 7/00; G01S 7/481; G01S 17/89; G06V 20/05; G06V 20/58

(52) U.S. Cl. CPC G01S 17/93; G01S 7/003; G01S 7/4815; G01S 7/4817; G01S 17/89; G06V 20/05; G06V 20/58

(57) ABSTRACT

A system for three-dimensional spatial perception underwater that includes a primary submersible vehicle. Frontward facing projectors are used to scan beams of light across a selected field of underwater view. Further, event cameras with pixels triggered by events are used to detect corresponding spots of the scanned beams that are reflected from underwater objects or surfaces. Circuitry is configured to determine positions of the objects based on the pixels that are triggered. Additionally, pilot submersible vehicles the projectors and event cameras are tethered to the primary submersible vehicle to provide extend detection of spots corresponding to reflections from underwater objects or surfaces.

### CROSS-REFERENCE TO RELATED APPLICATION

This application is a Utility Patent application based on previously filed U.S. Provisional Patent Application U.S. Ser. No. 63/556,663 filed on Feb. 22, 2024, the benefit of the filing date of which is hereby claimed under 35 U.S.C. § 119(e), and the contents of which is further incorporated in entirety by reference.

### TECHNICAL FIELD

The present innovations relate generally three-dimensional (3D) perception of objects and surfaces, and more particularly to underwater (3D) perception of the position and location of objects and surfaces.

### BACKGROUND

State of the art computer systems rely on the computationally advanced signal processing of frames of images. In these conventional systems image frames are perused for “features” which are typically clusters of pixels that reveal “structure”, e.g. the edge of an object being imaged—that is rendered by a process of reversed projection, light intensity variances from pixel to pixel, searching for patterns of contrast between neighboring pixels that vary in grey scale (a measure of light intensity, i.e. photons received during a certain time period—the exposure time of a frame). Many real-world things get in the way for this essential first step in computer vision to reliably result in useful actional information. Motion blur, lack of focus, lack of photons (i.e., “photon starvation”) and often plainly an insufficiency of contrast available (e.g., fading signs, lack of color contrast, invisibility of 3d shapes due to excessive diffuse lighting such as lack of shadows in fog or excessively uneven lighting).

Underwater perception systems are subject to additional challenges. Although sonar is commonly used, it has limited speed and resolution. Cameras and Lidar can be used to extract both 2-D and 3-D data from objects in the water, but both can fail to achieve much detail when there is even a moderate amount of turbidity. Lidar, in particular, is highly susceptible to backscattering of light. Scanning laser-based triangulations systems can ameliorate many of these problems, yet these systems can also miss certain details under challenging conditions. This becomes even more important when perception systems are mounted and used on moving objects. Underwater vehicles have great need for accurate perception of their surroundings.

### BRIEF DESCRIPTION OF THE DRAWINGS

FIG. 1A is a perspective view of a 3-D perception system in an underwater vehicle in accordance with specific embodiments of the invention.

FIGS. 1B and 1C are close-up views of a portion of the system of FIG. 1A.

FIG. 2A is a process showing methods of 3-D perception using the system of FIG. 1A in accordance with specific embodiments of the invention.

FIG. 2B is a perspective view of a 3-D perception system in an underwater vehicle in accordance with specific embodiments of the invention.

FIG. 3 is a close-up view of a retroreflective element mounted on a pilot vehicle.

FIG. 4 is an alternate configuration of a 3-D perception system in an underwater vehicle in accordance with specific embodiments of the invention.

FIG. 5A is a projection subsystem for use in a 3-D perception system in accordance with specific embodiments of the invention.

FIG. 5B is a diagram illustrating details of use of the projection subsystem of FIG. 5A.

FIG. 6 is a diagram illustrating configurations used to detect scattering at various distances from a primary vehicle.

### DETAILED DESCRIPTION OF THE INVENTION

Underwater vehicles are often equipped with a variety of ways to obtain information of surrounding conditions. Sonar and cameras are in common use in these vehicles. Sonar can give results at relatively high range in many conditions but does not return high resolution data. At short to medium range, camera systems can fill the gap, but become much less effective when water conditions are cloudy. Turbidity and attenuation in general can greatly decrease the range of visibility of many perception systems. Even when the range is acceptable, detail that can be captured is often reduced, even under mildly turbid conditions. Laser scanning triangulation systems have been described previously that can obtain high-resolution data even under turbid conditions, but other improvements are possible. Mounted on vehicles, perceptions systems may need to have low latency to be able to detect objects that are in the motion path of the vehicles, with sufficient detail to be able to recognize the objects as dangerous or not.

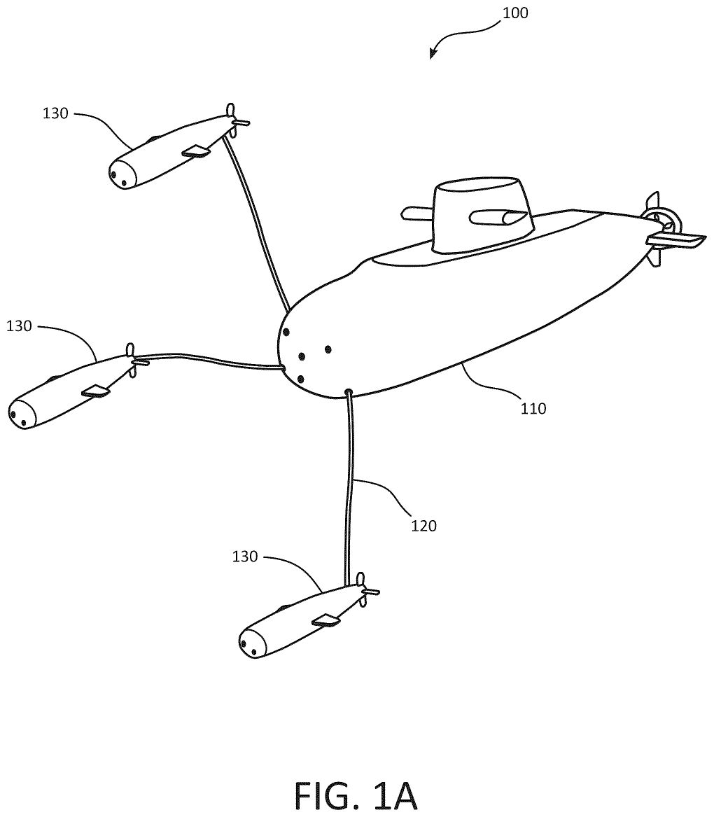

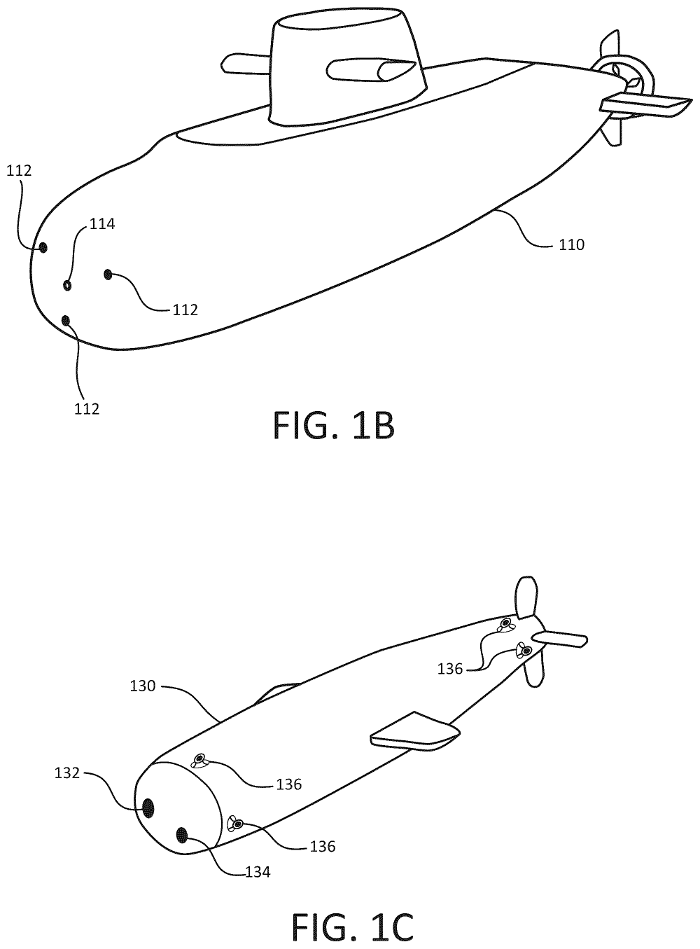

FIG. 1A shows an underwater vehicle with a perception system according to one embodiment. The system 100 includes a primary vehicle 110. For example, the vehicle 110 may be a submarine as shown here. The submarine may be manned or unmanned, but other vehicle types are possible, including remotely operated vehicles (ROV). The submarine is attached by tethers 120 to one or more pilot vehicles 130. Pilot vehicles 130 are not necessarily shown to scale; their length may be a significant fraction of the vehicle 110, but in some embodiments, they may be much smaller, having a length of 2% or less of the main vehicle 110. The figures show elements of scanning triangulation systems as part of the system 100, but individual elements of the system such as a submarine 110 or a pilot vehicle 130 may include additional sensors as well, such as sonar or frame image capture cameras. In some embodiments, the primary vehicle may have one or more portions underwater. For example, a surface ship may be able to use pilot vehicles to detect obstacles under the surface, for surveillance around the vehicle, or other environmental awareness.

A close-up view of the submarine 110 is shown in FIG. 1B. The submarine 110 generally has propulsion and steering mechanisms, as well as other sensors such as sonar, Lidar, or video cameras which are not depicted here. The submarine has its own scanning triangulation subsystem comprising one or more laser scanners 114, and two or more event-type cameras 112 to detect reflections from scanned beams. Event-type cameras may be event cameras that detect changes in light, avalanche photodiode arrays (APDs), photo-multiplier tube arrays (PMTs), or others, but in general they can detect light changes and report the time light is captured for each pixel individually. The system as shown has cameras and a scanner mounted on the front of the submarine. Triangulation detection can increase its range and accuracy as scanners and cameras in the system are separated with greater disparity, so in some embodiments, cameras might be mounted farther out to the side on a superstructure that extends away from the vehicle hull. In some embodiments, the superstructure may lie flush against the hull to decrease water resistance but be deployed at other times with additional event-type cameras mounted to improve triangulation quality. In relatively clear water, the range of the triangulation system mounted on the submarine 110 may be sufficient to capture details of objects at farther range and capture high-resolution images (in 2-D or 3-D) at closer range.

When moving at any significant speed, low-latency perception may be used to detect objects that are in or near the movement path of the vehicle. At low turbidity levels, data from the submarine triangulation subsystem may still be sufficient to capture object surface data at tens of meters, giving time for evasive steering or braking to be taken if necessary. At medium or high levels of turbidity or attenuation, the scanning range is much shorter for light-based scanning methods. Under these conditions, in current use sonar is one of the major modes used for detection of upcoming objects. However, sonar cannot see through some conditions, such as thermal or concentration gradients, that light can see through. In addition, some objects, for example fishing nets, are barely detectable or not at all with sonar. Scanning triangulation may be able to detect nets and other objects that do not have an appreciable cross-section detectable by sonar out to 50 meters or more, but this range may be reduced substantially under turbidity.

In some embodiments of the invention, portions of system 100 may be used to increase the detection range from the submarine itself. This may include one or more pilot vehicles 130. A close-up view of a pilot vehicle 130 is shown in FIG. 1C. The pilot vehicles may have one or more event cameras 132. In some embodiments, a pilot vehicle 130 may have a laser scanner 134 as well. If a pilot vehicle has multiple cameras, they may be configured differently; for example, one event camera may have a wider FOV, while another may have a narrow FOV. Choosing one or both of these cameras can allow foveation of the system to objects of interest, where the narrow FOV camera may be able to perceive higher detail about objects than the wider FOV camera when turned in that direction. Pilot vehicles may also have propulsion and steering elements as well. Though the power to enable propulsion may be self-contained within the pilot vehicle 130, in some embodiments, a tether 120 connecting the pilot vehicle can supply power to the pilot vehicle to run propulsion, steering, and/or sensing components. Propulsion may be a propeller along with steering fins, but pilot vehicles may be made more agile by optionally using various water jets 136 distributed around the vehicle. Some are shown in FIG. 1C, though there may be other distributed in other locations. Smaller water jets could be used for steering or other positioning where stronger water jets in the rear might be used for main propulsion. Water jets 136 may be steerable, but in some embodiments, they may be fixed in position. In the latter case, internal valves or motors could vary the amount and timing of water coming out of the various jets so as to give precision control over the attitude and velocity of the pilot vehicle.

Tethers 120 may also include optical or other communication cables that facilitate communication between the primary vehicle 110 and the pilot vehicles 130. In specific embodiments, positioning of the pilot vehicles may be configurable and chosen based on environmental conditions or other factors. In a coordinate system, if the Z-axis represents the forward movement of the submarine, then the pilot vehicles could be steered so that they are separated away from the submarine in the X, Y-axis plane, where in the Z-direction, the pilot vehicles are near the plane of the front of the primary vehicle. However, they may also be moved significantly farther forward along the Z-axis of movement of the submarine so that they are in front on the submarine. This may enable perception of the volume of water the submarine will be moving into and could be especially useful where water is cloudy and vision systems at the submarine are less reliable.

In some embodiments, a pilot vehicle 130 may have two or more event-type cameras 132 to enable local scanning triangulation near the pilot vehicle 130. However, range in general is limited in triangulation by disparity among various elements such as the laser scanner and the cameras. System 100 with multiple cameras or other elements spread out between the pilot vehicles 130 can provide much more disparity than the same elements on a single vehicle. General operation of such a scanning system 100 has been described before but can be summarized as follows. In some embodiments, a scanning beam from scanner 114 may scan quickly across a chosen field of view (FOV) in front of the submarine 110. Various event cameras 112 and 132 can be calibrated with respect to each other. The beam may intersect with various objects, for example, hulls of surface boats, marine life, underwater vehicles, the seafloor, or others. Each event camera that has the intersection spot of the beam with an object may have one or more pixels triggered with events that correspond to that beam on the object at that specific time. Event cameras can report to a central processor their position in the event camera sensor space, and because the position of each camera is calibrated and known, the position of the reflected spot with respect to all vehicles can be determined. A single scan over an object may be captured as a series of connected events called a trajectory. In some embodiments, more than one scanning beam may be used simultaneously to more fully cover the scene with scanned beams. In this case, trajectories captured can be matched among the various cameras and then used for triangulation.

In specific embodiments, the primary vehicle 110 may be the sole source of scanning beams. In this case, the one or more beams would come from laser scanners on the primary vehicle. One or more event cameras on the pilot vehicles 130 can observe reflected spots from objects from these scanning beams. In specific embodiments, scanning beams from one or more pilot vehicles can be used for scanning beams. Pilot vehicle scanning beams may be used instead of those from the primary vehicle, or may be used to supplement these beams. All event cameras that can observe any of the reflected spots from the various lasers can add in triangulation data. Because the system overall is able to disambiguate the various trajectories, many scanning beams from different locations can be used simultaneously, which can improve the scanning coverage of the system. In some embodiments, environmental considerations may determine the best configuration at the time. In many cases, a laser from the primary vehicle might be more powerful than those installed on a pilot vehicle. However, in especially cloudy water with high scattering or other attenuation, a beam from the primary vehicle might not be able to make it to objects surrounding the system; in this case, it may be beneficial to use scanning beams from the pilot vehicles that may be closer to obstacles or other objects.

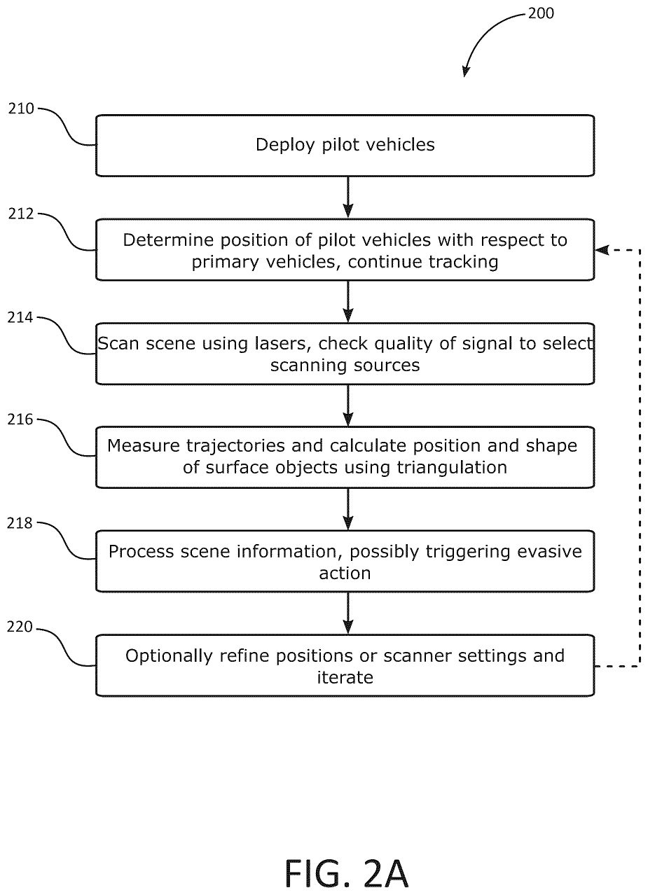

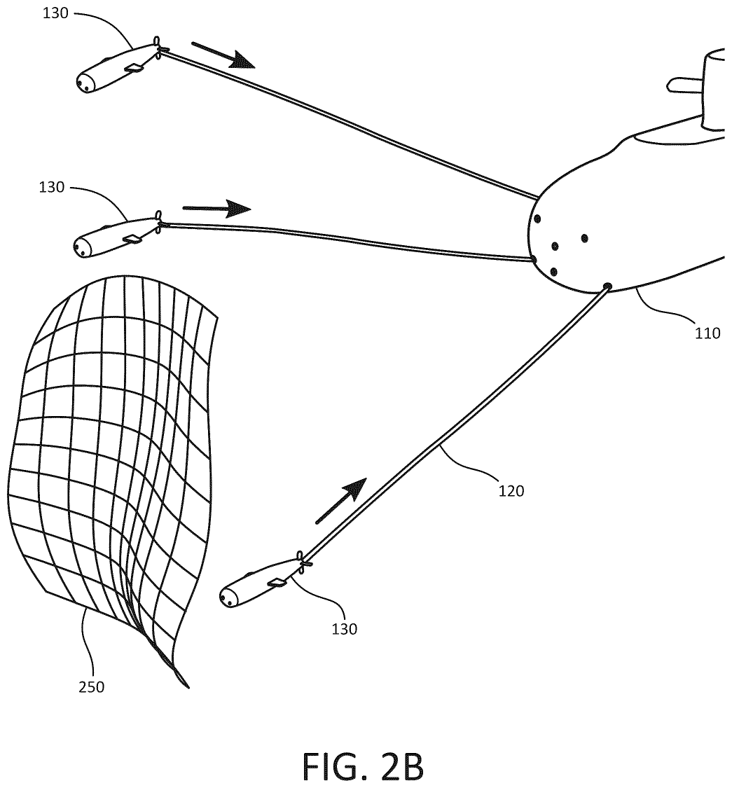

A general process for using the perception system 100 is outlined as process 200 in FIG. 2. In step 210, pilot vehicles 130 may be deployed from the primary vehicle 110. When not being used, they may be stored inside the primary vehicle, attached to the side, or in other configurations. Upon deployment, the propulsion of each pilot vehicle can move each pilot vehicle to near its desired location with respect to the primary vehicle. The location may be nearer the plane of the front of the primary vehicle, but in many cases, it will be useful to move them forward for both visibility and positioning.

In step 212, the position of the pilot vehicles can be determined. When objects around the system can be seen by all cameras readily, the position and orientation of system elements can be calibrated readily. This process has been described elsewhere, but in general scanning of trajectories on nearby objects (including the seafloor) can be detected at each camera positioning. Using bundle adjustment or other methods, the exact position of each camera can be determined. This calibration process can also be used to dynamically calibrate cameras while in use. In portions of the system, ongoing calibration is less necessary. For instance, when using the subsystem mounted directly on a submarine, the scanner 114 and cameras 112 will remain relatively stationary with respect to each other; once calibration has been done, other than vibrations, it will remain relatively intact. However, this is not true for remote portions of the system mounted on pilot vehicles. Even when the vehicles are at rest, there will still be constant movement of the water around that will disrupt position and orientation of each vehicle. This is especially true for pilot vehicles, which may have much less mass than the primary vehicle, and so be more susceptible to movement. While underway, the system as a whole may have more internal movements. The direction of thrust and steering may be able to at least partially overcome this in an attempt to maintain a pilot vehicle in the same position with respect to the primary vehicle. Continuing dynamic calibration will most likely be necessary so that the triangulation system has knowledge over time where all the active cameras and scanners are.

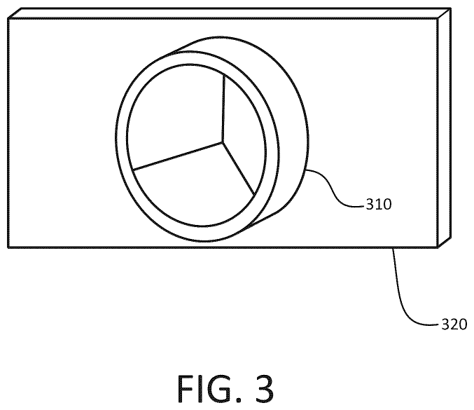

Dynamic calibration may not work in all conditions. Water turbidity may interfere in some circumstances, but commonly the cause will be lack of objects to measure within the system range. Unless the system is near enough to objects at all times to measured scanned beams, those beams cannot be used for ongoing calibration. In some embodiments, the pilot vehicles may have a reflective device to add in this. FIG. 3 shows a retroreflector 310 that can be mounted on a portion of a pilot vehicle. The retroreflector may be optionally mounted on a high-albedo plate 320 that scatters light in a roughly Lambertian manner. The retroreflector assembly can be mounted on the pilot vehicle near the rear, on the side, or in some position that will normally have line of light to the primary vehicle beam scanner 114. In some embodiments, multiple retroreflectors may be mounted on the pilot vehicle. When used for positioning, an additional sensor can be placed either very near the beam scanner or in line with the scanner using beam splitters or other methods. While the beam is being scanned, its angular position may be tracked internally. Beam power is often sufficient so that even diffuse scattering off objects surfaces may be measured by the event cameras. When the beam scans over a retroreflector on the pilot vehicle, the signal return will be comparatively large. Even in extremely cloudy conditions, a signal should be able to be measured. Though this sensor may also detect backscatter along the axis of the beam, the signal from the retroreflector may be much higher than scatter. A single return from a retroreflector can locate the angle of the pilot vehicle from the primary vehicle. Other configurations may return more positioning data. When two or more retroreflectors are mounted on the pilot vehicle, two different returns at different angles are available. If the exact mounting positions are known on the pilot vehicle, position and orientation are available as well. In some embodiments, a primary vehicle may have more than one beam scanner position spatially separated. If both beam scanners are equipped to measure return signal, then the position of the pilot vehicle can be directly triangulated, with additional rotational information available if there are multiple retroreflectors mounted as well. In embodiments where highly-scattering surfaces 320 are also present on the pilot vehicles, other information may be obtained using event cameras 112 as well. Triangulation data of trajectories captured on surfaces such as 320 can then be used to continuously locate each pilot vehicles position. Though a surface 320 specifically mounted for this purpose can be used, in some cases the steering fins, sides of the pilot vehicle, or other portions may be visible to the event cameras 112 as well providing similar information. Though this has been discussed where the main beam scanner is also used to measure return signal from a retroreflector, in some embodiments, one or more separate beam scanners with detectors could be used for this purpose. Though a discrete mirror retroreflector 310 is shown, retroreflectors may be instead an array of small elements such as a film or a spheres with high index of refraction that act as retroreflectors. Retroreflectors need not be entirely ideal; in some embodiments, reflected signal can be well-detected even if the return signal is spread in a small cone from the retroreflector. In this case, the return signal detector element can be located slightly off-axis near the output beam.

In step 214, water quality can be monitored using signal returns. Various metrics may be used. In some embodiments, the quality of object trajectories can be examined; if there are many dropouts where signal is not detected, this might be a sign that there is a high level of scattering or absorption in the water. Scattering may also be detected by viewing directly scattered light along the beam path as it heads toward objects. Event cameras may be sufficiently sensitive to pick up light in this path, though signal reflected from objects is often much stronger than scattered light. When water conditions change, the system overall may change parameters to adjust. For example, laser power may be increased to overcome measured absorption or scattering. In high attenuation conditions, choice of scanners activated may change as well. In clear conditions, the laser scanners on the primary vehicle might be used, but when attenuation increases, secondary scanners on one or more pilot vehicles may be activated.

In step 216, scanning of objects using scan trajectories can take place. Calculations of trajectories from each camera's perspective can be combined through triangulation and knowledge of each camera's position at that moment. This leads to 3-D trajectories in space corresponding to object surfaces. Generally, the data stream is relatively continuous, in that object surface information is not reported in clusters such as frames. In step 218, this data can be combined and processed for further action. In some embodiments, scene data can be used for classification. Classification may occur extremely quickly, and actions taken accordingly. In one example, the system may perceive that an object ahead is small and is a type of fish not directly within the submarine's path. In this case, no additional actions may be needed. In another example, a fishing net 250 may be detected in the path of the submarine. One example is shown in FIG. 2B. The system can deliver overall position of the net 250 and assist in determining whether the submarine may be able to steer around the net 250, or may otherwise need to fully stop. In the latter case, the tethers on all the pilot vehicles may immediately be engaged to yank the pilot vehicles back closer to the submarine as the submarine brakes or otherwise avoids the net or other obstacle. The mass differential between the two types of vehicles should make this possible. Even if a pilot vehicle were scaled 1/10th the length of the primary vehicle, it would have on the order of 0.1% of its mass. This would enable the primary vehicle to pull the pilot vehicles back very quickly so that the pilot vehicles would not collide or otherwise become entangled in an obstacle. Relatively smaller pilot vehicles could react and be moved even more quickly. Depending on the position of the obstacle, other actions may occur. In this example, if the net is blocking a single pilot vehicle 130 and not the primary vehicle 110, that pilot vehicle could be pulled quickly back, allowing the primary and pilot vehicles system to continue moving on their path without disruption. Though the system overall can be used for 3-D perception, in collision or obstacle avoidance, it may be sufficient to treat it as an accurate early warning system.

In step 220, the process is repeated. Water conditions or other factors may change which may signal iterate steps to remeasure position more accurately, or switch to other modes.

The system has been described for use while under movement, but in some embodiments, the system can be used for other perception tasks. When the primary vehicle 110 is not moving (or moving slowly), it may be desirable to examine objects more closely in detail in the water or near the seafloor. In this case, the pilot vehicles 130 could be used as ROVs for close inspection. For close work, two or more pilot vehicles 130 could be maneuvered to be near objects to be measured. Range and disparity of the multiple pilot vehicles can be set to capture the level of detail necessary. In this manner, the pilot vehicles can be used to obtain a high-resolution 3-D scan of an object or objects in the scene. In configurations where pilot vehicles also include frame capture video cameras, surface color and texture details can be captured as well; because frame capture cameras can also be well calibrated with other cameras in the system, color and texture details may also be added into 3-D models of the scene.

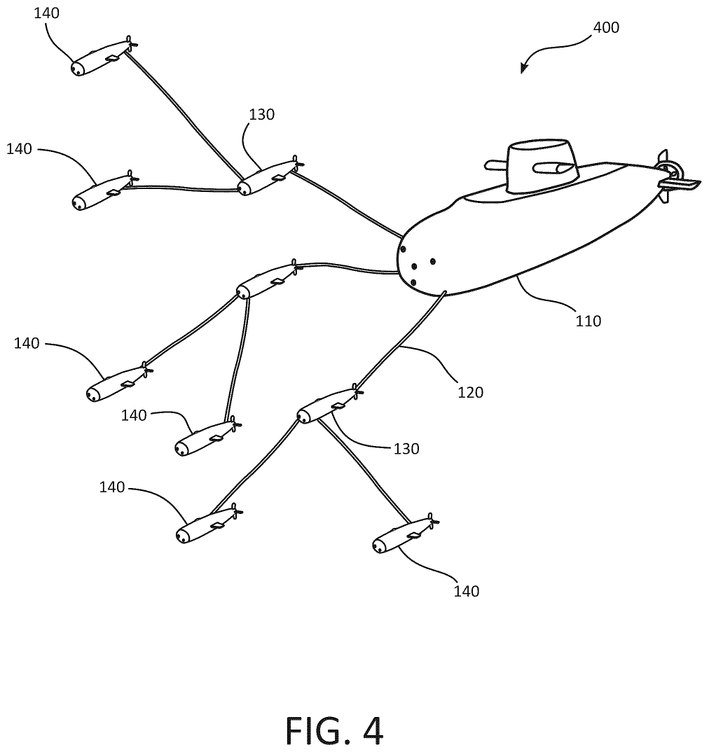

In specific embodiments, there may be multiple layers of pilot vehicles configured to work at different distances from the primary vehicle. FIG. 4 shows one possible configuration. In this example, three pilot vehicles 130 are directly attached to a submarine 110. Six more pilot vehicles 140 could be attached to the first set of pilot vehicles 130 in a second layer that may then be able to measure the scene at a greater distance. In some embodiments all pilot vehicles could be tethered directly to the primary vehicles, though the configuration may end up similar to FIG. 4 where various pilot vehicles are at different distances from the primary vehicle.

In specific embodiments, pilot vehicles can be used in an untethered mode. This may be more difficult, since communication between various systems is crucial both for transmitting signals to be processed, but also to continually calibrate the system positioning and parameters. Retroreflectors can assist with this application. In a similar manner to portions of step 212, a scanning beam can detect the angular position of each pilot vehicle from the primary vehicle. Continual tracking of the retroreflector position by the scanning beam can then enable a communication beam to be aimed at the pilot vehicle, which may have a sensor mounted near the retroreflector for one-way laser communication. In some embodiments, the pilot vehicle may have a separate laser that can be aimed for communication back to the primary vehicle. In other embodiments, the retroreflector can be used as a communication device; here the incoming communication beam can be modulated through movement of the retroreflector position using piezoelectrics or other actuators. Phase or position can be changed to change the beam reflecting to the primary vehicle. This change in modulation of the incoming beam could then be used for two-way communication. Multiple communication lasers could be used on the primary vehicle, though alternatively one could be used which rapidly switches among the pilot vehicles to capture saved data chunks intermittently for processing. The same process 200 can be used for perception as outlined previously. Though position calibration relies further on retroreflectors in this mode, calibration as described can still be accomplished using methods strictly from measuring scanned beams with many cameras as in the tethered case. In specific embodiments, additional position information can be refined from captured scan reflections. Camera position and orientation can be calculated as mentioned previously from many measurements of objects in the FOVs of all cameras. In cases where there are significant objects (or the seafloor) where there are many signal events to measure trajectories, then more precise event camera coordinates can be found. In some cases, where the line-of-sight laser communication is broken and can't be found, fallback communications can be used. For example, an ultrasonic transmitter can send updates back to a receiver on the primary vehicle; though this can be much lower bandwidth than a laser communicator, a subset of event data can be transmitted that is sufficient to locate each of the cameras. This may aid in restoring higher-speed communications or may be used on its own when visual communications are impaired during conditions of high water turbidity to achieve at least a low-resolution 3-D scan.

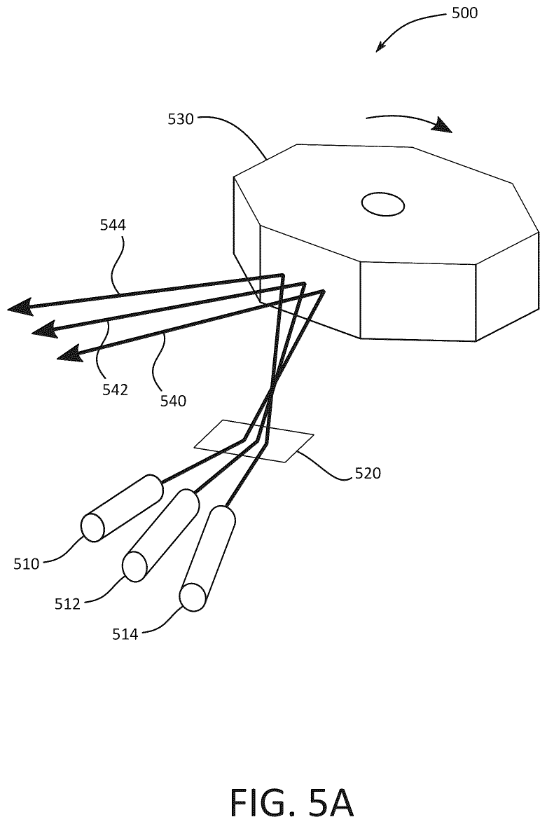

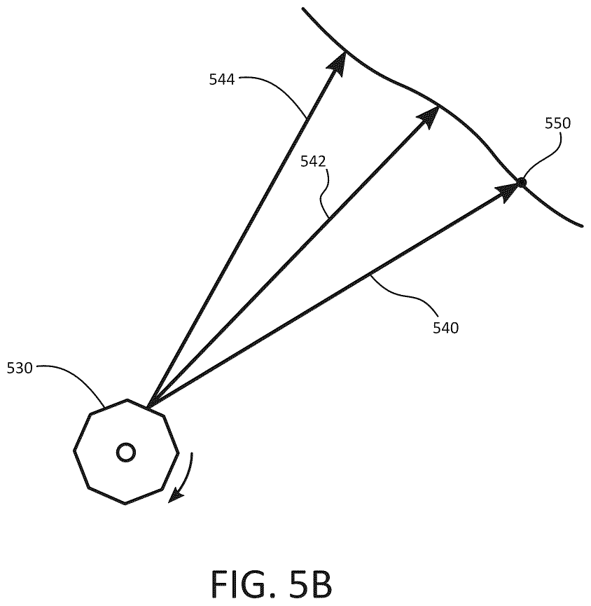

In some embodiments, signal for perception may be improved under difficult conditions by modifying the laser beam scanner to repeat two or more scanned beams at the same angle at different times. Laser beam scanners can be configured in a variety of ways to output one or multiple beams. FIG. 5A shows one example of a beam scanner 500 according to specific embodiments. One standard configuration is a poly-galvo scanner similar to that of scanner 500. In that configuration, three lasers are aimed at a steering mirror 520, and then beams are directed to a spinning mirrored polygon 530. This can create a fan of beams that provides fuller scanning coverage of the scene. In this embodiment, the three lasers 510, 512, and 514 are aligned so that the spread of beams lie along planes perpendicular to the spinning axis of the polygon 530. The resulting output beams 540, 542, and 544 can be output in a generally linear shape at any one time. The scanning speed of the mirror 520 and the polygon spin rate can be chosen so that subsequent beams are output at roughly the same angle consecutively. When scanning an object, the result is that the three beams will hit at the substantially same spot on the object one after another with a known cadence. FIG. 5B shows a top view of beam scanner 500 with three beams hitting an object. In the drawing, beam 540 is hitting the object at a point 550 at a time t₀. When the system is properly aligned, beams 542 and 544 will also hit the object at point 550 at later times, t₁ and t₂ respectively. Because the rotating polygon spins at a predictable speed at a chosen angular velocity ω, then the differences Δt₂₁=t₂−t₁ and Δt₃₂=t₃−t₂ should remain constant regardless of the distance between the scanner and the object. Signal events thus have a clear rhythm based on these time differentials.

In some configurations, this could be detectable directly at the event level on a given event camera. When this happens, an event could trigger three times at the same (X,Y) position on the event camera. For example, in a system scanning beams at 200 Hz, the sweep time of one of the beams across the scene may be about 5 milliseconds. The angles of three beams 540, 542, 544 can be adjusted so that later beams overlap the same output angle every 1.0 milliseconds, though these values are arbitrary (this could be 200 microseconds or 3 milliseconds and still be effective). Thus, an event might trigger three times at that pixel separate by 1.0 millisecond. In clear conditions, this might be redundant information, but could be very useful when there is significant attenuation where there may be noise levels higher than the signal. Scattered light can be taken out of the signal in many conditions but might otherwise still be present at high levels when there is high turbidity. In this embodiment, to qualify as a signal event, three events would need to be detected at that spot with the specific time pattern of separation. Scattering or other noise events tend to be uncorrelated in time, and so could be filtered out of the stream of events to be processed. Though this has been described at the event level, this technique could also be used in other configurations for an entire scan trajectory, where it would be expected that the trajectory would follow at intervals of 1.0 millisecond. In this way, even if some signal events are missed, the overall time-parameterized curve fit to the event data would have a very reproducible time step and be clearly distinguishable from noise.

This method of detection can help out additionally when objects measured have sparse surfaces. On relatively continuous surfaces, scanned beams traverse the object surface. Events captured are pieced together to create trajectories. Because the trajectories can be curve-fit with time-parameterized functions, accuracy of points sampled on the curves can have sub-pixel resolution and lower time resolution than that of the event camera itself. This can aid in matching among various cameras for triangulation and improve accuracy as well as ensure object detection. This method may not be available on a sparse object. One example of a sparse object is a fishing net, where beams that intersect the net may most of the time pass through gaps in the net. Reflection from the net gives a sharp, bright signal that can be readily detected as one or more events, but events because the ropes in the net may not be wide, the events may not be trivial to assemble into trajectories. This makes them appear similar to noisy events with additional possibilities of rejection. Using the rhythm of two or more spots at expected time differences can act as an additional filter that will make surfaces such as this more apparent.

Other variations of system 500 are possible. Though this illustration used three beams, it would work with two, four or more beams. Also, in the illustration, the angular overlap time between the first and second beam, 1.0 millisecond, was identical to that between the second and third, this does not have to be the case, so long as the interval is precisely known. By using the system and comparing timing intervals over a series of many events, the exact time intervals can be measured and calibrated. Though three lasers are shown here to create the three beams, in some embodiments a single laser may be projected through a diffractive optical element (DOE) to split the beam into three parts. Careful alignment and rotation of the DOE will lead to beams that significantly overlap along their scan path. The timing may change depending on where in the optical path a DOE is placed. If a DOE is after the scanning system, there may be some nonlinear effects in the positioning of higher diffractive order beams as they change vertical and horizontal positions. Though the angular speed may be slightly changed, it should be consistent at each (X,Y) position in each event camera, and any deviations can be calibrated at each scan line position.

In the simplest configuration, the lasers 510, 512, and 514 can be aligned to be as close as possible to overlapping when the polygon 530 rotates, it may be sufficient to align them near to the ideal condition. In this case, the three beams may be close to overlapping, but appear to be slightly separated lines. As long as the angles are relatively small, this may be calibrated out of the system as well. For example, if beams 540 and 544 substantially overlap with each other, but beam 542 is slightly vertically offset, then events captured from beam 542 would still appear 1.0 millisecond after those from beam 540 but be captured at a slightly different pixel location on each event camera. This as well can be calibrated out. This may work well within a certain tolerance; if the angle is spread too far, then variation of the surface of objects could change the perceived spot position and not give an event at that position. Similar calibration of shifted position could be done when comparing delayed scan trajectories by time intervals as well. Though scanner 500 has been described as requiring the angles to be the same for the output beams at different time intervals, this may not be exactly true at surface objects. While measuring objects that are moving, or when elements of the system are moving, then subsequent scans at the time interval may actually hit at different positions, which might change the captured event data. Other movement might be internal portions; if the vertical steering mirror 520 is moving with any significant speed, this might also offset the beams before they can hit the same spot on an object. Both of these effects can be ameliorated by scanning at faster speeds. For instance, if the beams time interval from scanner 500 is 100 microseconds, then there would be less time for objects to move. In some embodiments, analysis of event data can ameliorate movement effects as well. As the scanning mirror 520 moves, the speed at which it is moving may be predictable. Mirror 520 might be scanning in a sinusoidal manner. When it is moving slowly, the beams may substantially overlap, but in the middle of its cycle, this may spread out the overlapped beams. Since this movement is predictable, the event can be expected to be captured at known offset positions based on this speed and thus tracked. Similarly, when objects are moving, the movements may be slow enough not to affect the three-beam capture position, but if movement is faster, it may still be predictable enough in a short time interval so that the shifted beams at time intervals can be tracked similarly.

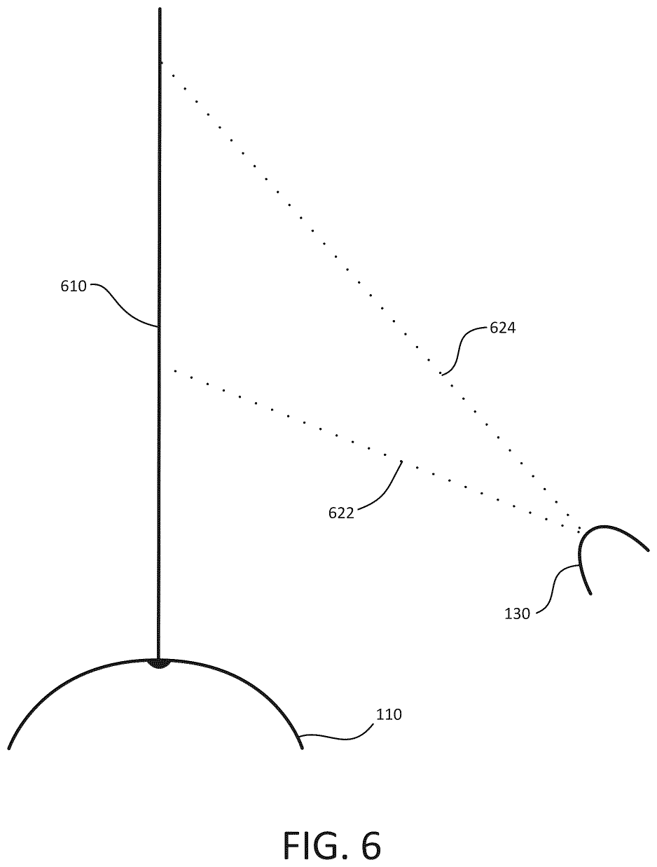

In some embodiments, elements of step 214 may be used to monitor water clarity directly without using 3-D perception. In a simplified system, as few as one pilot vehicle could be used to monitor the area ahead of the primary vehicle. When significant turbidity is detected by scattered light coming from a scanning beam and detected at the pilot vehicle's cameras, it may send a signal that water clarity is changing rapidly. This may serve as an additional early warning system that the speed of the vehicle should be reduced. This is illustrated in FIG. 6, which shows a portion of a single pilot vehicle 130 along with the front of the primary vehicle 110. Beam 610 shows a beam aiming in the directional axis of the primary vehicle from the front. The beam 610 may be a scanning beam used for 3-D perception, but in some cases might be a dedicated beam that may not need to scan. Event camera pixels can image along at least a portion of the beam. At moderate levels of turbidity, the triangulation system will not be able to see reflected signals at far distances. Though this might be seen as object detection distance lowers, this may not be detectable immediately as there may not be suitable objects scanned while water quality is changing. That is, when traversing an area with few objects to scan, water clarity cannot be estimated at all times by scanning. As turbidity increases, scattering increases as well. Event camera sensors capable of detecting signals from objects tens of meters can also be sensitive enough to detect light scattering along the path of the beam 610. At lower turbidity levels, light scattering can be less, but may be detectable at further distances, for example along line 624 on event cameras mounted on pilot vehicle 130. As turbidity increases, the distance scattered light may be detected at decreases, for instance, as scattered light might be detectable as far as line 622 on the event camera. Backscatter might be measured directly at sensors mounted near the beam 610, which may also give an indication of turbidity, but this may be difficult to quantify since attenuation is composed of scattering as well as absorption. Changes in water from one area to the next may have a variable change in each portion of attenuation, so by measuring from an angle, a more consistent value can be produced. Further information might be gained in some configurations by combining side scatter measurements with backscatter values.

Although the invention has been discussed with respect to various embodiments, it should be recognized that the invention comprises the novel and non-obvious claims supported by this disclosure.

1. A system comprising:
one or more projectors that scan one or more beams across a selected field of view in an underwater environment, wherein the or more projectors are adapted to mount forward facing on a primary submersible vehicle;
one or more event cameras that comprise a plurality of pixels, wherein one or more portions of the pixels are triggered by one or more events corresponding to one or more reflections of the one or more beams from one or more of an object or a surface located in the underwater environment, and wherein the one or more event cameras are adapted to mount to the submersible vehicle; and
one or more processors that execute actions including obtaining one or more three-dimensional (3D) positions of the one or more of the object or the surface located in the underwater environment based on the one or more pixel portions triggered by the one or more events.

2. The system of claim 1, further comprising:
one or more other event cameras that comprise one or more portions of other pixels that are triggered by one or more other events corresponding to detection of one or more other reflections in the underwater environment, wherein the one or more other event cameras are adapted to mount to one or more secondary submersible vehicles.

3. The system of claim 2, further comprising:
one or more other projectors that scan one or more other beams across another selected field of view in the underwater environment, wherein the more or more other projectors are adapted to mount forward facing on the one or more secondary submersible vehicles.

4. The system of claim 2, further comprising:
a communication link that is adapted for communication between the submersible vehicle and the one or more secondary submersible vehicles, wherein the detection of the one or more other events is communicated to the primary submersible vehicle in the underwater environment.

5. The system of claim 2, wherein the one or more secondary submersible vehicles are configured to move in front of a direction of travel for the submersible vehicle in the underwater environment.

6. The system of claim 2, wherein the communication link further comprises:
a tether that is adapted to form a physical connection between the primary submersible vehicle and the one or more secondary submersible vehicles, wherein the tether comprises one or more of an optical fiber, an electronic cable, a radio frequency (RF) cable or an acoustic waveguide.

7. The system of claim 2, wherein the communication link further comprises:
a wireless connection that is adapted for communication between the submersible vehicle and the one or more secondary submersible vehicles, wherein the wireless connection comprises one or more of a laser signal, an infrared signal, an RF signal, or an acoustic signal.

8. The system of claim 2, further comprising:
one or more retroreflectors that are adapted to attach to the one or more secondary submersible vehicles, wherein one or more retro reflector reflections of the one or more beams are used to obtain dynamic calibration of a 3D position of the one or more secondary submersible vehicles relative to the submersible vehicle in the underwater environment.

9. The system of claim 8, wherein the one or more reflectors further comprise:
one or more high albedo plates that are adapted to mount the one or more retroreflectors to the secondary submersible vehicle to scatter the one or more reflections in a Lambertian arrangement in the underwater environment.

10. The system of claim 1, wherein the one or more projectors further comprise:
two or more laser sources that are configured to output a plurality of laser beams that overlap at an angular position at different time intervals in the underwater environment.

11. The system of claim 10, wherein the overlap of the plurality of beams further comprises:
sequentially overlapping the plurality of beams at a same location with a known cadence to filter out noise in the underwater environment.

12. The system of claim 1, wherein the one or more processors perform further actions, comprising:
detecting one or more amounts of attenuation or scattering of the one or more beams in the underwater environment; and
adjusting power for the one or more beams based on the one or more amounts of attenuation or scattering.

13. The system of claim 1, wherein the one or more processors perform further actions, comprising:
detecting an amount of turbidity in the underwater environment based on an amount of scattering detected by the one or more event cameras for the one or more beams.

14. The system of claim 1, wherein the one or more event cameras, further comprise:
a first event camera having a wide field of view and a second event camera having a narrow field of view to obtain a foveated perception in the selected field of view.

15. The system of claim 1, further comprising:
one or more frame capture cameras that are configured to detect one or more of a color or a texture for the one or more of the object or the surface in the underwater environment.

16. The system of claim 1, wherein the one or more processors perform further actions, comprising:
detecting one or more sparse objects in the underwater environment based on one or more sparse patterns associated with the one or more reflections, wherein the one or more sparse objects include a net.

17. The system of claim 1, wherein the one or more projectors further comprise:
a scanner having a steering mirror and a rotating mirrored polygon that is configured to control one or more directions of the one or more beams.

18. The system of claim 1, wherein the one or more processors perform further actions, comprising:
assembling the one or more events into one or more time-parameterized trajectories to obtain sub-pixel resolution position accuracy.

19. A method, comprising:
employing one or more projectors to scan one or more beams across a selected field of view in an underwater environment, wherein the one or more projectors are adapted to mount frontward facing on a submersible vehicle;
employing one or more event cameras that comprise a plurality of pixels, wherein one or more portions of the pixels are triggered by one or more events corresponding to one or more reflections of the one or more beams from one or more of an object or a surface located in the underwater environment, and wherein the one or more event cameras are adapted to mount to the submersible vehicle; and
obtaining one or more three-dimensional (3D) positions of the one or more of the object or the surface located in the underwater environment based on the one or more pixel portions triggered by the one or more events.

20. A computer readable non-transitory storage media that includes instructions, wherein execution of the instructions by one or more processors causes performance of actions, comprising:
employing one or more projectors to scan one or more beams across a selected field of view in an underwater environment, wherein the one or more projectors are adapted to mount frontward facing on a submersible vehicle;
employing one or more event cameras that comprise a plurality of pixels, wherein one or more portions of the pixels are triggered by one or more events corresponding to one or more reflections of the one or more beams from one or more of an object or a surface located in the underwater environment, and wherein the one or more event cameras are adapted to mount to the submersible vehicle; and
obtaining one or more three-dimensional (3D) positions of the one or more of the object or the surface located in the underwater environment based on the one or more pixel portions triggered by the one or more events.
